(19) United States
(12) Patent Application Publication
(10) Pub. No.: US 2025/0151792 A1
(43) Pub. Date: May 15, 2025

(54) AEROSOL DELIVERY SYSTEM

(71) Applicant: NICOVENTURES TRADING LIMITED, London (GB)

(72) Inventors: James SHERIDAN, London (GB); Joseph Peter SUTTON, London (GB); Tom WOODMAN, London (GB)

(21) Appl. No.: 18/722,770

(22) PCT Filed: Dec. 9, 2022
(86) PCT No.: PCT/GB2022/053155

§ 371 Date: Jun. 21, 2024

(30) Foreign Application Priority Data
Dec. 22, 2021 (GB) 2118829.7

(51) Int. Cl. A24F 40/46; A24F 40/10; A24F 40/485; H05B 3/22

(52) U.S. Cl. CPC A24F 40/46; A24F 40/10; A24F 40/485; H05B 3/22

(57) ABSTRACT

An article for use as part of a non-combustible aerosol provision system, the article including a housing having at least one air inlet; and a substantially planar aerosol generating component, the substantially planar aerosol generating component being housed within the housing, wherein the at least one air inlet is configured to channel air towards the aerosol generating component in an inlet airflow direction, wherein the plane of the substantially planar aerosol generating component is obliquely angled with respect to the inlet airflow direction.

### RELATED APPLICATIONS

The present application is a National Phase entry of PCT Application PCT/GB2022/053155 filed Dec. 9, 2022, which claims priority to GB Application No. 2118829.7 filed Dec. 22, 2021, each of which is hereby incorporated by reference in their entirety.

### FIELD

The present invention relates to a delivery system, in particular to a non-combustible aerosol delivery system and to components of said aerosol delivery system. The present invention further relates to methods of generating and delivering an aerosol using the non-combustible aerosol delivery system and components disclosed herein.

### BACKGROUND

Non-combustible aerosol delivery systems which generate an aerosol for inhalation by a user are known in the art. Such systems typically comprise an aerosol generator which is capable of converting an aerosolizable material into an aerosol. In some instances, the aerosol generated is a condensation aerosol whereby an aerosolizable material is first vaporized and then allowed to condense into an aerosol. In other instances, the aerosol generated is an aerosol which results from the atomization of the aerosolizable material. Such atomization may be brought about mechanically, e.g. by subjecting the aerosolizable material to vibrations so as to form small particles of material that are entrained in airflow. Alternatively, such atomization may be brought about electrostatically, or in other ways, such as by using pressure etc.

Since such aerosol delivery systems are intended to generate an aerosol which is to be inhaled by a user, consideration should be given to the characteristics of the aerosol produced. These characteristics can include the size of the particles of the aerosol, the total amount of the aerosol produced, etc.

Where the aerosol delivery system is used to simulate a smoking experience, e.g. as an e-cigarette or similar product, control of these various characteristics is especially important since the user may expect a specific sensorial experience to result from the use of the system.

It would be desirable to provide aerosol delivery systems which have improved control of these characteristics.

### SUMMARY

According to an aspect of the present disclosure, there is provided an article for use as part of a non-combustible aerosol provision system, the article comprising:
a housing having at least one air inlet; and
a substantially planar aerosol generating component, the substantially planar aerosol generating component being housed within the housing,
wherein the at least one air inlet is configured to channel air towards the aerosol generating component in an inlet airflow direction, wherein the plane of the substantially planar aerosol generating component is obliquely angled with respect to the inlet airflow direction.

In some examples, the plane of the substantially planar aerosol generating component is angled by about 140° to about 160° with respect to the inlet airflow direction.

In some examples, the plane of the substantially planar aerosol generating component is angled by about 130° to about 150° with respect to the inlet airflow direction.

In some examples, the plane of the aerosol generating component is obliquely angled with respect to the inlet airflow direction in one or more directions.

In some examples, the plane of the aerosol generating component is obliquely angled with respect to the inlet airflow direction in only one direction.

In some examples, the housing comprises an aerosol forming chamber.

In some examples, the aerosol generating component is at least partly located within the aerosol-forming chamber.

In some examples, the housing defines a single air flow channel.

In some examples, the single airflow channel extends between the at least one air inlet and at least one air outlet.

In some examples, the aerosol generating component comprises one or more elongate apertures.

In some examples, the aerosol generating component is formed of an electrically conductive material.

In some examples, the aerosol generating material is formed of a porous material.

In some examples, the aerosol generating component is formed of a single layer.

In some examples, the aerosol generating component comprises one or more electrical connectors.

In some examples, the article comprises a reservoir for aerosolizable material.

In some examples, the article comprises an aerosol generation material transfer component configured to transfer (e.g. by capillary force) aerosolizable material from the reservoir to the aerosol generating component.

According to an aspect of the present disclosure, there is provided a non-combustible aerosol provision system comprising: an article according to a previous aspect; and a device comprising one or more of a power source and a controller.

According to an aspect of the present disclosure, there is provided an article for use as part of a non-combustible aerosol provision system, the article comprising: an aerosol generating component; and an aerosol generating material transfer component configured to transfer aerosol generating material to the aerosol generating component, wherein the aerosol generating component and the aerosol generating material transfer component are magnetically connected to each other.

In some examples, one of the aerosol generating component and the aerosol generating material transfer component comprises a magnetic material and the other of the aerosol generating component and the aerosol generating material transfer component comprises a corresponding magnetic material.

In some examples, one or both of the magnetic material and the corresponding magnetic material is a permanent magnet

In some examples, one or both of the magnetic material and the corresponding magnetic material is a temporary magnet or an electromagnet.

In some examples, the aerosol generating component is substantially planar.

In some examples, the aerosol generating component is curved.

In some examples, the aerosol generating component is curved around an axis of the aerosol generating component.

In some examples, the aerosol generating material transfer component is curved around the axis of the aerosol generating component.

In some examples, the article comprises an aerosol forming chamber.

In some examples, the aerosol generating component is at least partly located in the aerosol forming chamber.

In some examples, the aerosol generating component comprises one or more elongate apertures.

In some examples, the aerosol generating component comprises a plurality of elongate heating portions. The plurality of elongate heating portions may be arranged side-by-side.

In some examples, an elongate aperture is provided between adjacent elongate heating portions.

In some examples, the aerosol generating component is formed of an electrically conductive material.

In some examples, the aerosol generating material is formed of a porous material.

In some examples, the aerosol generating component is formed of a single layer.

In some examples, the aerosol generating component and the aerosol generating material transfer component are non-permanently connected to each other.

In some examples, the aerosol generating component and the aerosol generating material transfer component are releasably connected to each other.

In some examples, the article comprises a reservoir for aerosolizable material.

In some examples, the aerosol generating material transfer component is configured to transfer aerosolizable material from the reservoir to the aerosol generating component.

According to an aspect of the present disclosure, there is provided a non-combustible aerosol provision system comprising: an article according to a previous aspect; and a device comprising one or more of a power source and a controller.

According to an aspect of the present disclosure, there is provided an aerosol generating component comprising: at least two substantially planar portions, wherein at least two of the substantially planar heating portions lie in a different plane from each other.

In some examples, at least two of the substantially planar portions lying in a different plane define an oblique internal angle.

In some examples, the internal angle is between about 30° and about 60°.

In some examples, the internal angle is between about 40° and about 50°.

In some examples, at least two of the substantially planar portions lying in a different plane are connected to each other end-to-end.

In some examples, the aerosol generating component (e.g. one or each of the at least two substantially planar portions) comprises one or more elongate apertures.

In some examples, the aerosol generating component (e.g. one or each of the at least two substantially planar portions) comprises multiple elongate heating portions. The multiple elongate heating portions may be arranged side by side.

In some examples, an elongate aperture is provided between adjacent elongate heating portions.

In some examples, the aerosol generating component is configured such that airflow travels perpendicular to a boundary between the at least two substantially planar portions lying in a different plane.

In some examples, the aerosol generating component is formed of an electrically conductive material.

In some examples, the aerosol generating component is formed of a porous material.

In some examples, the aerosol generating component is formed of a single layer.

According to an aspect of the present disclosure, there is provided an article for use as part of a non-combustible aerosol provision system, the article comprising: an aerosol generating component according to a previous aspect; and one or more of a reservoir for aerosolizable material, and an aerosol forming chamber.

In some examples, the aerosol generating component is provided at least partly within the aerosol forming chamber.

In some examples, the article comprises at least one air inlet to the aerosol-forming chamber.

In some examples, the aerosol generating component is arranged to channel air entering the article via the at least one air inlet onto at least two of the substantially planar portions lying in a different plane.

In some examples, at least two of the substantially planar portions lying in a different plane are arranged to direct air entering the article via the at least one air inlet is in different directions.

In some examples, the oblique internal angle is at the side of the aerosol generating component distal from the at least one air inlet.

In some examples, the article is configured such that airflow (e.g. entering via the at least one air inlet) travels perpendicular to a boundary between the at least two substantially planar portions lying in a different plane.

According to an aspect of the present disclosure, there is provided a non-combustible aerosol provision system comprising: an article according to a previous aspect; and a device comprising one or more of a power source and a controller.

According to an aspect of the present disclosure, there is provided an article for use as part of a non-combustible aerosol provision system, the article comprising: a housing; an aerosol generating component; and an aerosol generating material transfer component, the aerosol generating component and the aerosol generating material transfer component being housed within the housing, wherein the aerosol generating component is urged against the aerosol generating material transfer component.

In some examples, the aerosol generating component is securely attached to the housing or a component therein.

In some examples, the aerosol generating component comprises one or more electrical connectors securely attached to one or more corresponding electrical contacts in the housing.

In some examples, the aerosol generating material transfer component is spatially constrained by the housing or a component therein.

In some examples, the aerosol generating component is substantially planar.

In some examples, the aerosol generating component is curved.

In some examples, the aerosol generating component is curved around an axis of the aerosol generating component.

In some examples, the aerosol generating material transfer component is curved around the axis of the aerosol generating component.

In some examples, the axis of the aerosol generating component is one or more of the longitudinal axis of the aerosol generating component and an axis extending between electrical contacts of the aerosol generating component.

In some examples, the article comprises an aerosol forming chamber.

In some examples, the aerosol generating component is at least partly located in the aerosol forming chamber.

In some examples, the aerosol generating component comprises one or more elongate apertures.

In some examples, the aerosol generating component comprises multiple elongate heating portions. The plurality of elongate heating portions may be arranged side-by-side.

In some examples, an elongate aperture is provided between adjacent elongate heating portions.

In some examples, the aerosol generating component is formed of an electrically conductive material.

In some examples, the aerosol generating material is formed of a porous material.

In some examples, the aerosol generating component is formed of a single layer.

In some examples, the housing defines at least one airflow channel.

According to an aspect of the present disclosure, there is provided a non-combustible aerosol provision system comprising: an article according to a previous aspect; and a device comprising one or more of a power source and a controller.

It is possible to configure the system such that the airflow channel(s) and/or the aerosol generating chamber(s) and/or the aerosol generating component(s) are separable. For example, the article may be provided in a modular form in which the airflow channel(s) and/or the aerosol generating chamber(s) and/or the aerosol generating component(s) are separable.

According to another aspect of the present disclosure, there is provided:

A1. An article for use as part of a non-combustible aerosol provision system, the article comprising: an aerosol generating component; and an aerosol generating material transfer component configured to transfer aerosol generating material to the aerosol generating component, wherein the aerosol generating component and the aerosol generating material transfer component are magnetically connected to each other.

A2. An article of clause A1, wherein one of the aerosol generating component and the aerosol generating material transfer component comprises a magnetic material and the other of the aerosol generating component and the aerosol generating material transfer component comprises a corresponding magnetic material.

A3. An article of clause A2, wherein one or both of the magnetic material and the corresponding magnetic material is a permanent magnet.

A4. An article of clause A2 or A3, wherein one or both of the magnetic material and the corresponding magnetic material is a temporary magnet or an electromagnet.

A5. An article of any one of clauses A1-A4, wherein the aerosol generating component is substantially planar.

A6. An article of any one of clauses A1-A5, wherein the aerosol generating component is curved.

A7. An article of clause A6, wherein the aerosol generating component is curved around an axis of the aerosol generating component.

A8. An article of clause A7, wherein the aerosol generating material transfer component is curved around the axis of the aerosol generating component.

A9. An article of any one of clauses A1-A8, comprising an aerosol forming chamber.

A10. An article of any one of clauses A1-A9, wherein the aerosol generating component is at least partly located in the aerosol forming chamber.

A11. An article of any one of clauses A1-A10, wherein the aerosol generating component comprises one or more elongate apertures.

A12. An article of any one of clauses A1-A11, wherein the aerosol generating component is formed of an electrically conductive material.

A13. An article of any one of clauses A1-A12, wherein the aerosol generating component is formed of a porous material.

A14. An article of any one of clauses A1-A13, wherein the aerosol generating component is formed of a single layer.

A15. An article of any one of clauses A1-A14, wherein the aerosol generating component and the aerosol generating material transfer component are non-permanently connected to each other.

A16. An article of any one of clauses A1-A15, wherein the aerosol generating component and the aerosol generating material transfer component are releasably connected to each other.

A17. An article of any one of clauses A1-A16, comprising a reservoir for aerosolizable material, wherein the aerosol generating material transfer component is configured to transfer aerosolizable material from the reservoir to the aerosol generating component.

A18. A non-combustible aerosol provision system comprising: an article of any one of clauses A1-A17; and a device comprising one or more of a power source and a controller.

According to another aspect of the present disclosure, there is provided:

B1. An aerosol generating component comprising: at least two substantially planar portions, wherein at least two of the substantially planar portions lie in a different plane from each other.

B2. An aerosol generating component of clause B1, wherein at least two of the substantially planar portions lying in a different plane define an oblique internal angle.

B3. An aerosol generating component of clause B2, wherein the internal angle may be between about 30° and about 60°.

B4. An aerosol generating component of clause B3, wherein the internal angle may be between about 40° and about 50°.

B5. An aerosol generating component of any one of clauses B1-B4, wherein at least two of the substantially planar portions lying in a different plane are connected to each other end-to-end.

B6. An aerosol generating component of any one of clauses B1-B5, comprising one or more elongate apertures.

B7. An aerosol generating component of clause B6, comprising multiple elongate heating portions.

B8. An aerosol generating component of clause B7, wherein an elongate aperture is provided between adjacent elongate heating portions.

B9. An aerosol generating component of any one of clauses B1-B8, configured such that airflow travels perpendicular to a boundary between the at least two substantially planar portions lying in a different plane.

B10. An aerosol generating component of any one of clauses B1-B9, formed of an electrically conductive material.

B11. An aerosol generating component of any one of clauses B1-B10, formed of a porous material.

B12. An aerosol generating component of any one of clauses B1-B11, formed of a single layer.

B13. An article for use as part of a non-combustible aerosol provision system, the article comprising: an aerosol generating component of any one of clauses B1-B12; and one or more of a reservoir for aerosolizable material, and an aerosol forming chamber.

B14. An article of clause B13, wherein the aerosol generating component is provided at least partly within the aerosol forming chamber.

B15. An article of clause B13 or B14, comprising at least one air inlet to the aerosol-forming chamber.

B16. An article of clause B15, wherein the aerosol generating component is arranged to channel air entering the article via the at least one air inlet onto at least two of the substantially planar portions lying in a different plane.

B17. An article of clause B15 or B16, wherein at least two of the substantially planar portions lying in a different plane are arranged to direct air entering the article via the at least one air inlet in different directions.

B18. An article of any one of clauses B15 to B17, wherein the aerosol generating component is characterised according to clause B2, wherein the oblique internal angle is at the side of the aerosol generating component distal from the at least one air inlet.

B19. An article of any one of clauses B13 to B18, configured such that airflow travels perpendicular to a boundary between the at least two substantially planar portions lying in a different plane.

B20. A non-combustible aerosol provision system comprising: an article of any one of clauses B13-B19; and a device comprising one or more of a power source and a controller.

According to another aspect of the present disclosure, there is provided:

C1. An article for use as part of a non-combustible aerosol provision system, the article comprising: a housing; an aerosol generating component; and an aerosol generating material transfer component, the aerosol generating component and the aerosol generating material transfer component being housed within the housing, wherein the aerosol generating component is urged against the aerosol generating material transfer component.

C2. An article of clause C1, wherein the aerosol generating component is securely attached to the housing or a component therein.

C3. An article of clause C1 or C2, wherein the aerosol generating component comprises one or more electrical connectors securely attached to one or more corresponding electrical contacts in the housing.

C4. An article of any one of clauses C1-C3, wherein the aerosol generating material transfer component is spatially constrained by the housing or a component therein.

C5. An article of any one of clauses C1-C3, wherein the aerosol generating material transfer component is not securely attached to the housing or a component therein.

C6. An article of any one of clauses C1-C5, wherein the aerosol generating component is substantially planar.

C7. An article of any one of clauses C1-C6, wherein the aerosol generating component is curved.

C8. An article of clause C7, wherein the aerosol generating component is curved around an axis of the aerosol generating component.

C9. An article of clause C7 or C8, wherein the aerosol generating material transfer component is curved around the axis of the aerosol generating component.

C10. An article of any one of clauses C1-C9, comprising an aerosol forming chamber.

C11. An article of clause C10, wherein the aerosol generating component is at least partly located in the aerosol forming chamber.

C12. An article of any one of clauses C1-C11, wherein the aerosol generating component comprises one or more elongate apertures.

C13. An article of any one of clauses C1-C12, wherein the aerosol generating component is formed of an electrically conductive material.

C14. An article of any one of clauses C1-C13, wherein the aerosol generating component is formed of a porous material.

C15. An article of any one of clauses C1-C14, wherein the aerosol generating component is formed of a single layer.

C16. An article of any one of clauses C1-C15, wherein the housing defines at least one airflow channel.

C17. A non-combustible aerosol provision system comprising: an article of any one of clauses C1-C16; and a device comprising one or more of a power source and a controller.

It will be appreciated that features of the invention described above in relation to any aspect of the invention are equally applicable to, and may be combined with, embodiments of the invention according to any other aspect of the invention as appropriate, and not just in the specific combinations described above.

### BRIEF DESCRIPTION OF THE DRAWINGS

Various embodiments will now be described in detail by way of example only with reference to the accompanying drawings in which:

FIG. 1 is a schematic representation of an aerosol provision system according to the present disclosure.

FIG. 2 is a diagram of an article for use as part of an aerosol provision system according to the present disclosure.

FIG. 3 is an exploded diagram of the article of FIG. 2.

FIG. 4A is a schematic diagram of an exemplary aerosol generating component according to the present disclosure.

FIG. 4B is a schematic diagram of an exemplary aerosol generating component according to the present disclosure.

FIG. 4C is a schematic diagram of an exemplary aerosol generating component according to the present disclosure.

FIG. 5A is a schematic diagram of an exemplary aerosol generating component according to the present disclosure.

FIG. 5B is a schematic diagram of an exemplary aerosol generating component according to the present disclosure.

FIG. 5C is a schematic diagram of an exemplary aerosol generating component according to the present disclosure.

FIG. 5D is a schematic diagram of an exemplary aerosol generating component according to the present disclosure.

FIG. 6 is a schematic diagram of an exemplary article (although various parts of the article are omitted for clarity) for use as part of an aerosol provision system according to the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) non-combustible aerosol provision systems and devices that generate an aerosol from an aerosol-generating material (or aerosolizable material) without combusting the aerosol-generating material. Examples of such systems include electronic cigarettes, tobacco heating systems, and hybrid systems (which generate aerosol using a combination of aerosol-generating materials). In some examples, the non-combustible aerosol provision system is an electronic cigarette, also known as a vaping device or electronic nicotine delivery system (END), although it is noted that the presence of nicotine in the aerosol-generating material is not a requirement of the present disclosure. In some examples, the non-combustible aerosol provision system is an aerosol-generating material heating system, also known as a heat-not-burn system. An example of such a system is a tobacco heating system. In some examples, the non-combustible aerosol provision system is a hybrid system to generate aerosol using a combination of aerosol-generating materials, one or a plurality of which may be heated. Each of the aerosol-generating materials in such a hybrid system may be, for example, in the form of a solid, liquid or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

Throughout the following description the terms “e-cigarette” and “electronic cigarette” may sometimes be used; however, it will be appreciated these terms may be used interchangeably with non-combustible aerosol (vapor) provision system or device as explained above.

In some examples, the present disclosure relates to consumables for holding aerosol-generating material, and which are configured to be used with non-combustible aerosol provision devices. These consumables are sometimes referred to as articles throughout the present disclosure.

The non-combustible aerosol provision system typically comprises a device part (i.e. a device) and a consumable/article part (i.e. an article). The device part typically comprises a power source and a controller. The power source may typically be an electrical power source, e.g. a rechargeable battery.

In some examples, the non-combustible aerosol provision system may comprise an area for receiving or engaging with the consumable/article, an aerosol generator (which may or may not be within the consumable/article), an aerosol generation area (which may be within the consumable/article), a housing, a mouthpiece, a filter and/or an aerosol-modifying agent.

In some examples, the consumable/article for use with the non-combustible aerosol provision device may comprise aerosol-generating material (i.e. aerosolizable material), an aerosol-generating material storage area (i.e. a reservoir for aerosolizable material), an aerosol-generating material transfer component (e.g. a wick, such as a pad), an aerosol generator (i.e. an aerosol generating component), an aerosol generation area (i.e. an aerosol generation chamber), a housing, a wrapper, a filter, a mouthpiece, and/or an aerosol-modifying agent.

The systems described herein typically generate an inhalable aerosol by vaporization of an aerosol generating material. The aerosol generating material may comprise one or more active constituents, one or more flavors, one or more aerosol-former materials, and/or one or more other functional materials.

Aerosol-generating material may, for example, be in the form of a solid, liquid or gel which may or may not contain an active substance and/or flavorants. In some examples, the aerosol-generating material may comprise an “amorphous solid”, which may alternatively be referred to as a “monolithic solid” (i.e. non-fibrous). In some examples, the amorphous solid may be a dried gel. The amorphous solid is a solid material that may retain some fluid, such as liquid, within it. In some examples, the aerosol-generating material may for example comprise from about 50 wt %, 60 wt % or 70 wt % of amorphous solid, to about 90 wt %, 95 wt % or 100 wt % of amorphous solid.

The term “active substance” as used herein may relate to a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

The aerosol-former material may comprise one or more constituents capable of forming an aerosol. In some examples, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

As used herein, the term “component” is used to refer to a part, section, unit, module, assembly or similar of an electronic cigarette or similar device that incorporates several smaller parts or elements, possibly within an exterior housing or wall. An electronic cigarette may be formed or built from one or more such components, and the components may be removably or separably connectable to one another, or may be permanently joined together during manufacture to define the whole electronic cigarette. The present disclosure is applicable to (but not limited to) systems comprising two components separably connectable to one another and configured, for example, as a consumable/article component capable of holding an aerosol generating material (also referred to herein as a cartridge or cartomizer), and a device/control unit having a battery for providing electrical power to operate an element for generating vapor from the aerosol generating material.

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) non-combustible aerosol provision systems and devices that generate an aerosol from an aerosol-generating material (which also may be referred to herein as aerosolizable material) without combusting the aerosol-generating material. Examples of such systems include electronic cigarettes, tobacco heating systems, and hybrid systems (which generate aerosol using a combination of aerosol-generating materials). In some examples, the non-combustible aerosol provision system is an electronic cigarette, also known as a vaping device or electronic nicotine delivery system (END), although it is noted that the presence of nicotine in the aerosol-generating material is not a requirement of the present disclosure. In some examples, the non-combustible aerosol provision system is an aerosol-generating material heating system, also known as a heat-not-burn system. An example of such a system is a tobacco heating system. In some examples, the non-combustible aerosol provision system is a hybrid system to generate aerosol using a combination of aerosol-generating materials, one or a plurality of which may be heated. Each of the aerosol-generating materials in such a hybrid system may be, for example, in the form of a solid, liquid or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

Throughout the following description the terms “e-cigarette” and “electronic cigarette” may sometimes be used; however, it will be appreciated these terms may be used interchangeably with non-combustible aerosol (vapor) provision system or device as explained above.

In some examples, the present disclosure relates to consumables for holding aerosol-generating material, and which are configured to be used with non-combustible aerosol provision devices. These consumables are sometimes referred to as articles throughout the present disclosure.

The non-combustible aerosol provision system typically comprises a device part (which also may be referred to herein as a device) and a consumable/article part which also may be referred to herein as an article). The device part typically comprises a power source and a controller. The power source may typically be an electrical power source, e.g. a rechargeable battery.

In some examples, the non-combustible aerosol provision system may comprise an area for receiving or engaging with the consumable/article, an aerosol generator (which may or may not be within the consumable/article), an aerosol generation area (which may be within the consumable/article), a housing, a mouthpiece, a filter and/or an aerosol-modifying agent.

In some examples, the consumable/article for use with the non-combustible aerosol provision device may comprise aerosol-generating material, an aerosol-generating material storage area which also may be referred to herein as a reservoir for aerosolizable material), an aerosol-generating material transfer component (e.g. a wick, such as a pad), an aerosol generator (which also may be referred to herein as an aerosol generating component), an aerosol generation area which also may be referred to herein as an aerosol generation chamber), a housing, a wrapper, a filter, a mouthpiece, and/or an aerosol-modifying agent.

The systems described herein typically generate an inhalable aerosol by vaporization of an aerosol generating material. The aerosol generating material may comprise one or more active constituents, one or more flavors, one or more aerosol-former materials, and/or one or more other functional materials.

Aerosol-generating material may, for example, be in the form of a solid, liquid or gel which may or may not contain an active substance and/or flavorants. In some examples, the aerosol-generating material may comprise an “amorphous solid”, which may alternatively be referred to as a “monolithic solid” (i.e. non-fibrous). In some examples, the amorphous solid may be a dried gel. The amorphous solid is a solid material that may retain some fluid, such as liquid, within it. In some examples, the aerosol-generating material may for example comprise from about 50 wt %, 60 wt % or 70 wt % of amorphous solid, to about 90 wt %, 95 wt % or 100 wt % of amorphous solid.

The term “active substance” as used herein may relate to a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

The aerosol-former material may comprise one or more constituents capable of forming an aerosol. In some examples, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

As used herein, the term “component” is used to refer to a part, section, unit, module, assembly or similar of an electronic cigarette or similar device that incorporates several smaller parts or elements, possibly within an exterior housing or wall. An electronic cigarette may be formed or built from one or more such components, and the components may be removably or separably connectable to one another, or may be permanently joined together during manufacture to define the whole electronic cigarette. The present disclosure is applicable to (but not limited to) systems comprising two components separably connectable to one another and configured, for example, as a consumable/article component capable of holding an aerosol generating material (also referred to herein as a cartridge or cartomizer), and a device/control unit having a battery for providing electrical power to operate an element for generating vapor from the aerosol generating material.

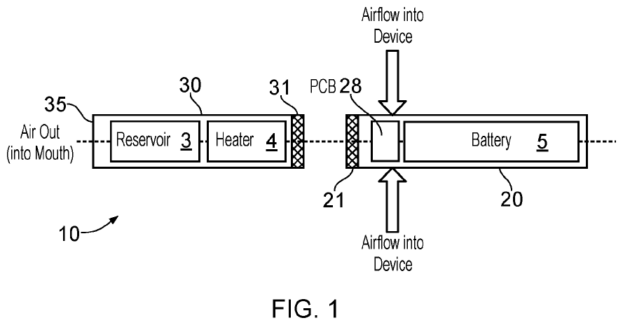

FIG. 1 is a highly schematic diagram (not to scale) of an example aerosol/vapor provision system such as an e-cigarette 10. The e-cigarette 10 may have a generally cylindrical shape, extending along a longitudinal axis indicated by a dashed line, and comprises two main components, namely a control or power component or section 20 (which also may be referred to herein as a device) and a cartridge assembly or section 30 (which also may be referred to herein as an article, consumable, cartomizer, or cartridge) that operates as a vapor generating component.

The cartridge assembly 30 includes a storage compartment (which also may be referred to herein as a reservoir) 3 containing an aerosolizable material comprising (for example) a liquid formulation from which an aerosol is to be generated, for example containing nicotine. As an example, the aerosolizable material may comprise around 1 to 3% nicotine and 50% glycerol, with the remainder comprising roughly propylene glycol, and possibly also comprising other components, such as water or flavorings. The storage compartment 3 has the form of a storage tank, being a container or receptacle in which aerosolizable material can be stored such that the aerosolizable material is free to move and flow (if liquid) within the confines of the tank. Alternatively, the storage compartment 3 may contain a quantity of absorbent material such as cotton wadding or glass fiber which holds the aerosolizable material within a porous structure. The storage compartment 3 may be sealed after filling during manufacture so as to be disposable after the aerosolizable material is consumed, or may have an inlet port or other opening through which new aerosolizable material can be added. The cartridge assembly 30 also comprises an electrical aerosol generating component 4 located externally of the reservoir tank 3 for generating the aerosol by vaporization of the aerosolizable material. In many devices, the aerosol generating component may be a heating element (heater) which is heated by the passage of electrical current (via resistive or inductive heating) to raise the temperature of the aerosolizable material until it evaporates. A liquid conduit arrangement such as a wick or other porous element (not shown) may be provided to deliver aerosolizable material from the storage compartment 3 to the aerosol generating component 4. The wick may have one or more parts located inside the storage compartment 3 so as to be able to absorb aerosolizable material and transfer it by wicking or capillary action to other parts of the wick that are in contact with the aerosol generating component 4. This aerosolizable material is thereby vaporized, to be replaced by new aerosolizable material transferred to the aerosol generating component 4 by the wick.

A heater and wick combination, or other arrangement of parts that perform the same functions, is sometimes referred to as an atomiser or atomiser assembly. Various designs are possible, in which the parts may be differently arranged compared to the highly schematic representation of FIG. 1. For example, the wick may be an entirely separate element from the aerosol generating component, or the aerosol generating component may be configured to be porous and able to perform the wicking function directly (by taking the form of a suitable electrically resistive mesh or capillary body, for example).

In some cases, the conduit for delivering liquid for vapor generation may be formed at least in part from one or more slots, tubes or channels between the storage compartment and the aerosol generating component which are narrow enough to support capillary action to draw source liquid out of the storage compartment and deliver it for vaporization. In general, an atomiser can be considered to be an aerosol generating component able to generate vapor from aerosolizable material delivered to it, and a liquid conduit (pathway) able to deliver or transport liquid from a storage compartment or similar liquid store to the aerosol generating component by a capillary force.

Typically, the aerosol generating component is at least partly located within an aerosol generation chamber that forms part of an airflow channel through the electronic cigarette/system. Vapor produced by the aerosol generating component is driven off into this chamber, and as air passes through the chamber, flowing over and around the aerosol generating component, it collects the produced vapor whereby it condenses to form the required aerosol.

Returning to FIG. 1, the cartridge assembly 30 also includes a mouthpiece 35 having an opening or air outlet through which a user may inhale the aerosol generated by the aerosol generating component 4, and delivered through the airflow channel.

The power component 20 includes a cell or battery 5 (which also may be referred to herein as a battery, and which may be re-chargeable) to provide power for electrical components of the e-cigarette 10, in particular the aerosol generating component 4. Additionally, there is a printed circuit board 28 and/or other electronics or circuitry for generally controlling the e-cigarette. The control electronics/circuitry connect the vapor generating element 4 to the battery 5 when vapor is required, for example in response to a signal from an air pressure sensor or air flow sensor (not shown) that detects an inhalation on the system 10 during which air enters through one or more air inlets 26 in the wall of the power component 20 to flow along the airflow channel. When the aerosol generating component 4 receives power from the battery 5, the aerosol generating component 4 vaporizes aerosolizable material delivered from the storage compartment 3 to generate the aerosol, and this is then inhaled by a user through the opening in the mouthpiece 35. The aerosol is carried to the mouthpiece 35 along the airflow channel (not shown) that connects the air inlet 26 to the air outlet when a user inhales on the mouthpiece 35. An airflow path through the electronic cigarette is hence defined, between the air inlet(s) (which may or may not be in the power component) to the atomiser and on to the air outlet at the mouthpiece. In use, the air flow direction along this airflow path is from the air inlet to the air outlet, so that the atomiser can be described as lying downstream of the air inlet and upstream of the air outlet.

In this particular example, the power section 20 and the cartridge assembly 30 are separate parts detachable from one another by separation in a direction parallel to the longitudinal axis, as indicated by the solid arrows in FIG. 1. The components 20, 30 are joined together when the device 10 is in use by cooperating engagement elements 21, 31 (for example, a screw, magnetic or bayonet fitting) which provide mechanical and electrical connectivity between the power section 20 and the cartridge assembly 30. This is merely an example arrangement, however, and the various components may be differently distributed between the power section 20 and the cartridge assembly section 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections may be intended to be disposed of and replaced when exhausted (the reservoir is empty or the battery is flat, for example), or be intended for multiple uses enabled by actions such as refilling the reservoir, recharging the battery, or replacing the atomiser. Alternatively, the e-cigarette 10 may be a unitary device (disposable or refillable/rechargeable) that cannot be separated into two or more parts, in which case all components are comprised within a single body or housing. Embodiments and examples of the present invention are applicable to any of these configurations and other configurations of which the skilled person will be aware.

As mentioned, a type of aerosol generating component, such as a heating element, that may be utilized in an atomising portion of an electronic cigarette (a part configured to generate vapor from a source liquid) combines the functions of heating and liquid delivery, by being both electrically conductive (resistive) and porous. Note here that reference to being electrically conductive (resistive) refers to components which have the capacity to generate heat in response to the flow of electrical current therein. Such flow could be imparted by via so-called resistive heating or induction heating. An example of a suitable material for this is an electrically conductive material such as a metal or metal alloy formed into a sheet-like form, i.e. a planar shape with a thickness many times smaller than its length or breadth. Examples in this regard may be a mesh, web, grill and the like. The mesh may be formed from metal wires or fibers which are woven together, or alternatively aggregated into a non-woven structure. For example, fibers may be aggregated by sintering, in which heat and/or pressure are applied to a collection of metal fibers to compact them into a single porous mass. It is possible for the planar aerosol generating component to define a curved plane and in these instances reference to the planar aerosol generating component forming a plane means an imaginary flat plane forming a plane of best fit through the component.

These structures can give appropriately sized voids and interstices between the metal fibers to provide a capillary force for wicking liquid. Thus, these structures can also be considered to be porous since they provide for the uptake and distribution of liquid. Moreover, due to the presence of voids and interstices between the metal fibers, it is possible for air to permeate through said structures. Also, the metal is electrically conductive and therefore suitable for resistive heating, whereby electrical current flowing through a material with electrical resistance generates heat. Structures of this type are not limited to metals, however; other conductive materials may be formed into fibers and made into mesh, grill or web structures. Examples include ceramic materials, which may or may not be doped with substances intended to tailor the physical properties of the mesh.

A planar sheet-like porous aerosol generating component of this kind can be arranged within an electronic cigarette such that it lies within the aerosol generation chamber forming part of an airflow channel. The aerosol generating component may be oriented within the chamber such that air flow though the chamber may flow in a surface direction, i.e. substantially parallel to the plane of the generally planar sheet-like aerosol generating component. An example of such a configuration can be found in WO2010/045670 and WO2010/045671, the contents of which are incorporated herein in their entirety by reference. Air can thence flow over the heating element, and gather vapor. Aerosol generation is thereby made very effective. In alternative examples, the aerosol generating component may be oriented within the chamber such that air flow though the chamber may flow in a direction which is substantially transverse to the surface direction, i.e. substantially orthogonally to the plane of the generally planar sheet-like aerosol generating component. An example of such a configuration can be found in WO2018/211252, the contents of which are incorporated herein in its entirety by reference.

The aerosol generating component may have any one of the following structures: a woven or weave structure, mesh structure, fabric structure, open-pored fiber structure, open-pored sintered structure, open-pored foam or open-pored deposition structure. Said structures are suitable in particular for providing a aerosol generating component with a high degree of porosity. A high degree of porosity may ensure that the heat produced by the aerosol generating component is predominately used for evaporating the liquid and high efficiency can be obtained. A porosity of greater than 50% may be envisaged with said structures. In one embodiment, the porosity of the aerosol generating component is 50% or greater, 60% or greater, 70% or greater. The open-pored fiber structure can consist, for example, of a non-woven fabric which can be arbitrarily compacted, and can additionally be sintered in order to improve the cohesion. The open-pored sintered structure can consist, for example, of a granular, fibrous or flocculent sintered composite produced by a film casting process. The open-pored deposition structure can be produced, for example, by a CVD process, PVD process or by flame spraying. Open-pored foams are in principle commercially available and are also obtainable in a thin, fine-pored design.

In one embodiment, the aerosol generating component has at least two layers, wherein the layers contain at least one of the following structures: a plate, foil, paper, mesh, woven structure, fabric, open-pored fiber structure, open-pored sintered structure, open-pored foam or open-pored deposition structure. For example, the aerosol generating component can be formed by an electric heating resistor consisting of a metal foil combined with a structure comprising a capillary structure. Where the aerosol generating component is considered to be formed from a single layer, such a layer may be formed from a metal wire fabric, or from a non-woven metal fiber fabric. Individual layers are advantageously but not necessarily connected to one another by a heat treatment, such as sintering or welding. For example, the aerosol generating component can be designed as a sintered composite consisting of a stainless steel foil and one or more layers of a stainless steel wire fabric (material, for example AISI 304 or AISI 316). Alternatively, the aerosol generating component can be designed as a sintered composite consisting of at least two layers of a stainless steel wire fabric. The layers may be connected to one another by spot welding or resistance welding. Individual layers may also be connected to one another mechanically. For instance, a double-layer wire fabric could be produced just by folding a single layer. Instead of stainless steel, use may also be made, by way of example, of heating conductor alloys-in particular NiCr alloys and CrFeAl alloys (“Kanthal”) which have an even higher specific electric resistance than stainless steel. The material connection between the layers is obtained by the heat treatment, as a result of which the layers maintain contact with one another-even under adverse conditions, for example during heating by the aerosol generating component and resultantly induced thermal expansions. Alternatively, the aerosol generating component may be formed from sintering a plurality of individual fibers together. Thus, the aerosol generating component can be comprised of sintered fibers, such as sintered metal fibers.

The aerosol generating component may comprise, for example, an electrically conductive thin layer of electrically resistive material, such as platinum, nickel, molybdenum, tungsten or tantalum, said thin layer being applied to a surface of the vaporizer by a PVD or CVD process, or any other suitable process. In this case, the aerosol generating component may comprise an electrically insulating material, for example of ceramic. Examples of suitable electrically resistive material include stainless steels, such as AISI 304 or AISI 316, and heating conductor alloys-in particular NiCr alloys and CrFeAl alloys (“Kanthal”), such as DIN material number 2,4658, 2,4867, 2,4869, 2,4872, 1,4843, 1,4860, 1,4725, 1,4765 and 1,4767.

As described above, the aerosol generating component may be formed from a sintered metal fiber material and may be in the form of a sheet. Material of this sort can be thought of a mesh or irregular grid, and is created by sintering together a randomly aligned arrangement or array of spaced apart metal fibers or strands. A single layer of fibers might be used, or several layers, for example up to five layers. As an example, the metal fibers may have a diameter of 8 to 12 μm, arranged to give a sheet of thickness 0.16 mm, and spaced to produce a material density of from 100 g/m² to 1500 g/m², such as from 150 g/m² to 1000 g/m², 200 g/m² to 500 g/m², or 200 to 250 g/m², and a porosity of 84%. The sheet thickness may also range from 0.1 mm to 0.2 mm, such as 0.1 mm to 0.15 mm. Specific thicknesses include 0.10 mm, 0.11 mm, 0.12 mm, 0.13 mm, 0.14 mm, 0.15 mm or 0.1 mm. Generally, the aerosol generating component has a uniform thickness. However, it will be appreciated from the discussion below that the thickness of the aerosol generating component may also vary. This may be due, for example, to some parts of the aerosol generating component having undergone compression. Different fiber diameters and thicknesses may be selected to vary the porosity of the aerosol generating component. For example, the aerosol generating component may have a porosity of 66% or greater, or 70% or greater, or 75% or greater, or 80% or greater or 85% or greater, or 86% or greater.

The aerosol generating component may form a generally flat structure, comprising first and second surfaces. The generally flat structure may take the form of any two dimensional shape, for example, circular, semi-circular, triangular, square, rectangular and/or polygonal. Generally, the aerosol generating component has a uniform thickness.

A width and/or length of the aerosol generating component may be from about 1 mm to about 50 mm. For example, the width and/or length of the vaporizer may be from 1 mm, 2 mm, 3 mm, 4 mm, 5 mm, 6 mm, 7 mm, 8 mm, 9 mm or 10 mm. The width may generally be smaller than the length of the aerosol generating component.

Where the aerosol generating component is formed from an electrically resistive material, electrical current is permitted to flow through the aerosol generating component so as to generate heat (so called Joule heating). In this regard, the electrical resistance of the aerosol generating component can be selected appropriately. For example, the aerosol generating component may have an electrical resistance of 2 ohms or less, such as 1.8 ohms or less, such as 1.7 ohms or less, such as 1.6 ohms or less, such as 1.5 ohms or less, such as 1.4 ohms or less, such as 1.3 ohms or less, such as 1.2 ohms or less, such as 1.1 ohms or less, such as 1.0 ohm or less, such as 0.9 ohms or less, such as 0.8 ohms or less, such as 0.7 ohms or less, such as 0.6 ohms or less, such as 0.5 ohms or less. The parameters of the aerosol generating component, such as material, thickness, width, length, porosity etc. can be selected so as to provide the desired resistance. In this regard, a relatively lower resistance will facilitate higher power draw from the power source, which can be advantageous in producing a high rate of aerosolization. On the other hand, the resistance should not be so low so as to prejudice the integrity of the aerosol generator. For example, the resistance may not be lower than 0.5 ohms.

Planar aerosol generating components, such as heating elements, suitable for use in systems, devices and articles disclosed herein may be formed by stamping or cutting (such as laser cutting) the required shape from a larger sheet of porous material. This may include stamping out, cutting away or otherwise removing material to create openings in the aerosol generating component. These openings can influence both the ability for air to pass through the aerosol generating component and the propensity for electrical current to flow in certain areas.

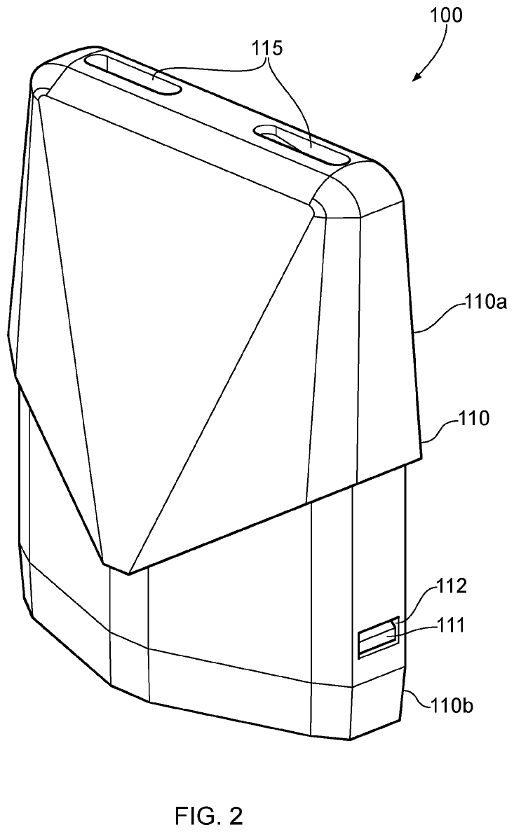

FIG. 2 is a diagram of an exemplary article 100 according to the present disclosure. The article 100 comprises a housing. In this specific example, the housing comprises an outer housing 110 and an inner housing 120. The outer housing 110 is formed by the coming together of first and second outer housing component 110a and 110b. The specific external appearance of the outer housing 110 is not limited, although in this specific example the outer housing 110 has a multi-faceted surface. The housing, for example the outer housing 110, may contain at least one outlet 115. In this specific example, there are two outlets 115. Said outlet(s) 115 is for conveying aerosol generated within the article 100 to the mouth of the user. Thus, in the example shown in FIG. 2, outer housing 110 also forms the mouthpiece of the article.

The first outer housing component 110a mates with the second outer housing component 110b so as to form outer housing 110. In this specific example, the components 110a, 110b fit together via a snap fit arrangement. In particular, resilient tabs 111 on the second outer housing component 110b (only one side of which is visible in FIG. 2), snap into corresponding receiving apertures 112 on first outer housing component 110a. It will be appreciated that the precise location of the tabs and apertures are not limited, and indeed the tabs may be formed on outer housing component 110a and apertures on outer housing component 110b.

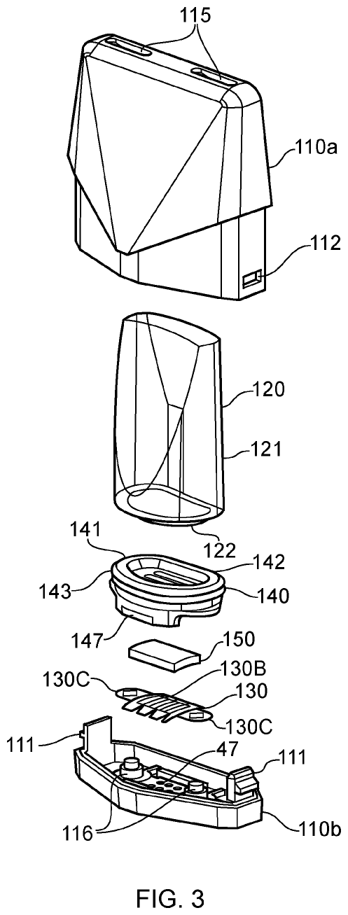

Referring to FIG. 3, the first outer housing component 110a is shown separated from second outer housing component 110b to reveal the inner housing component 120, an aerosol generating component 130 (which may be an electrically resistive metallic heater), a flow regulator 140, and a pad 150. The inner housing component 120 may be configured so as to define a storage area 121 for aerosolizable material (not shown). The inner housing component 120 may be sleeved at least partially inside first outer housing component 110a. Thus, the inner housing component 120 may be at least partially surrounded by the first outer housing component 110a. It is possible for the inner housing component 120 to be connected to the first outer housing component 110a (for example they may be attached together or part of the same molding). The inner housing component 120 may have an open end 122 which mates with flow regulator 140. Together, open end 122 and flow regulator 140 may define a path for aerosolizable material to flow from the storage area 121 to the pad 150. An optional mouthpiece (not shown) may be sleeved over the outside of the first outer housing component 110a (or the outer housing can form the mouthpiece).

The flow regulator 140 may contain a recess 141 into which the open end 122 of the inner housing component 120 can be received. The recess 141 may contain one or more openings 142 which allow for the flow of aerosolizable material through the flow regulator. In this specific example, the openings are slot shaped, but it will be appreciated that one or more of the openings may take a different cross section, such as circular, oval, or polygonal. Moreover, the cross sectional area of the one or more openings 142 may vary through the length of the flow regulator 140. Thus, the one or more openings 142 may have a larger cross sectional area at a location which is towards the liquid storage area compared to the cross sectional area at a location towards the pad 150. The flow regulator 140 may comprise an annular seal 143 around its perimeter which serves to inhibit egress of aerosolizable material from the boundary between inner housing component 120 and the flow regulator 140. The flow regulator 140 may comprise a surface against which the aerosol generating component 130 may be biased, and thus in some instances acts as a heater support.

The pad 150 may be formed of a capillary material which is suited to holding aerosolizable material. In particular, as aerosolizable material flows through flow regulator 140, the pad 150 may become saturated with aerosolizable material. However, due to the capillary nature of pad 150, leakage of aerosolizable material from pad 150 is inhibited. The aerosol generating component 130 may be located in proximity to pad 150 such that when the aerosol generating component 130 is energised (resistively heated in this specific example), aerosolizable material present in the pad 150 is vaporized. As explained above, the pad 150 and the aerosol generating component 130 may be combined as a single component.

In this specific example, the aerosol generating component 130 is arranged towards the second outer housing component 110b. Electrical contacts (e.g. pins) 116 on outer housing component 110b may contact the aerosol generating component 130 at electrical connectors (e.g. tabs) 130C so as to allow for electrical current to flow through aerosol generating component 130 during actuation of the system.

The second outer housing component 110b may contain at least one air inlet 117 which allows for air ingress into the article 100. During use, air may enter the article 100 via the at least one air inlet 117 whereby it mixes with vapor produced from aerosol generating component 130. The resulting aerosol may be then directed to the one or more air outlets 115 via at least one airflow channel which extends between the first outer housing component 110a and the inner housing component 120. For example, in this specific example, there are two airflow channels 180 that extend longitudinally along the length of the article 100 and cooperate with air outlets 115 so as to create a flow path through the article 100.

According to one aspect, there is disclosed an article for use as part of a non-combustible aerosol provision system, the article comprising: a housing having at least one air inlet; and a substantially planar aerosol generating component, the substantially planar aerosol generating component being housed within the housing, wherein the at least one air inlet is configured to channel air towards the aerosol generating component in an inlet airflow direction, wherein the plane of the substantially planar aerosol generating component is obliquely angled with respect to the inlet airflow direction.

It will be understood that the “inlet airflow direction” refers to the direction in which air is channelled through the at least one air inlet towards the aerosol generating component. By providing such an angle between the inlet airflow direction and the plane of the substantially planar aerosol generating component, the substantially planar aerosol generating component can direct air from the at least one air inlet in a particular direction through the article. In this way, the article can be manufactured with a single airflow channel, and air from the at least one air inlet can be effectively directed towards the airflow channel. This configuration can also help reduce airflow turbulence in the at least one airflow channel, relative to when the inlet airflow direction is substantially perpendicular to the plane of the substantially planar aerosol generating component. By reducing turbulence in the at least one airflow channel, the quality of generated aerosol can be improved.

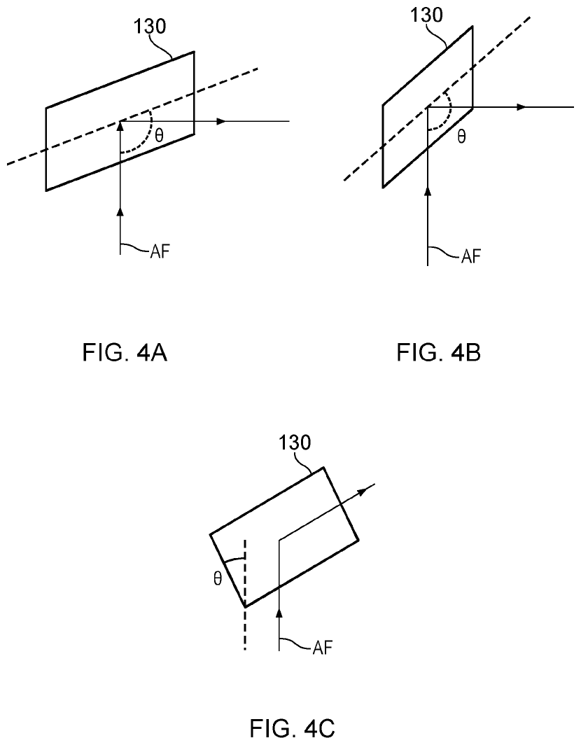

In this aspect, the article 100 may be as described hereinabove, except that the orientation of the aerosol generating component is different. For example, in the example of FIG. 2, it will be understood that the plane of the substantially planar aerosol generating component 130 is substantially perpendicular to the inlet airflow direction. By contrast, in this aspect, the plane of the substantially planar aerosol generating component 130 is obliquely angled with respect to the inlet airflow direction AF, as schematically depicted in FIGS. 4A-C.

Referring to FIG. 4A, in this specific example the plane of the substantially planar aerosol generating component 130 is angled by about 130° to about 140° (e.g. about) 135° with respect to the inlet airflow direction AF. It is envisaged that different angles may be used. For example, in the specific example of FIG. 4B, the plane of the substantially planar aerosol generating component 130 is angled by about 140° to about 160° (e.g. about) 150° with respect to the inlet airflow direction AF. In FIGS. 4A-C, the oblique angle is indicated by 0.

In some examples, the plane of the substantially planar aerosol generating component 130 is angled by about 100° to about 170°, or by about 110° to about 160°, or by about 120° to about 150°, or by about 130° to about 140° (e.g. about) 135°, with respect to the inlet airflow direction AF.

In some examples, the plane of the aerosol generating component 130 is obliquely angled with respect to the inlet airflow direction AF in one or more directions. Thus, the article may be capable of channelling airflow more effectively for certain configurations. In some examples, the plane of the aerosol generating component 130 is obliquely angled with respect to the inlet airflow direction AF in only one direction. In this connection, in the examples of FIGS. 4A and B, the plane of the aerosol generating component 130 is obliquely angled with respect to the inlet airflow direction AF in only one direction, i.e. along the length of the aerosol generating component 130. In the example of FIG. 4C, the plane of the aerosol generating component 130 is obliquely angled with respect to the inlet airflow direction AF in at least two directions, including the direction along the length of the aerosol generating component 130 and the direction along the width of the aerosol generating component 130 (the latter of which being indicated in FIG. 4C).

The oblique angle of the plane of the substantially planar aerosol generating component 130 with respect to the inlet airflow direction AF in the or each direction individually may be from about 100° to about 170°, or by about 110° to about 160°, or by about 120° to about 150°, or by about 130° to about 140° (e.g. about) 135°.

In some examples, the housing 110, 120 may comprise an aerosol forming chamber 190.

The aerosol generating component 130 may be at least partly located within the aerosol forming chamber 190.

The housing 110, 120 may define a single airflow channel 180 (a housing defining a single airflow channel is not illustrated in the FIGS. but will be understood by a person skilled in the art). In some examples, the single airflow channel 180 may extend between the at least one air inlet 117 and the at least one air outlet 115.

In some examples, the aerosol generating component 130 may comprise one or more elongate apertures 130B (e.g. as depicted in FIG. 3). The aerosol generating component 130 may comprise a plurality of elongate heating portions. The plurality of elongate heating portions may be arranged side-by-side. An elongate aperture 130B may be provided between adjacent elongate heating portions.

In some examples, the aerosol generating component 130 may be formed of an electrically conductive material. In some examples, the aerosol generating component 130 may be formed of a porous material. In some examples, the aerosol generating component 130 may be formed of a single layer.

The aerosol generating component 130 may comprise one or more electrical connectors 130C. The plurality of elongate heating portions may be provided between the electrical connectors 130C.

The article 100 may comprise any other features as defined herein.

There is also disclosed a non-combustible aerosol provision system 10 comprising: an article 100 as defined herein; and a device 20 comprising one or more of a power source and a controller.

The system 10 may comprise any other features as defined herein.

According to one aspect, there is disclosed an article for use as part of a non-combustible aerosol provision system, the article comprising: an aerosol generating component; and an aerosol generating material transfer component, configured to transfer aerosol generating material to the aerosol generating component, wherein the aerosol generating component and the aerosol generating material transfer component are magnetically connected to each other.

By virtue of the magnetic connection, there is improved contact between the aerosol generating component and the aerosol generating material transfer component, which can result in improved aerosolization. Moreover, the magnetic connection may simplify manufacture of the article, since the magnetic nature of the components can help to automatically align the components in the desired orientation.

The magnetic connection may be achieved in various different ways. For example, the aerosol generating component 130 and the aerosol generating material transfer component 150 may comprise, substantially consist of, consist essentially of, consist of, be coated with, and/or be formed from a magnetic material. Suitable magnetic materials will be known to the skilled person.

In some examples, one of the aerosol generating component 130 and the aerosol generating material transfer component 150 comprises a magnetic material and the other of the aerosol generating component 130 and the aerosol generating material transfer component 150 comprises a corresponding magnetic material. For example, one or both of the magnetic material and the corresponding magnetic material may be a permanent magnet. For example, one or both of the magnetic material and the corresponding magnetic material may be a temporary magnet or an electromagnet.

For example, the aerosol generating component 130 and the aerosol generating material transfer component 150 may be non-permanently connected to each other. For example, the aerosol generating component and the aerosol generating material transfer component may be releasably connected to each other. This may further simplify the process of manufacturing the article, relative to where a manufacturing step is required to permanently connect the aerosol generating component and the aerosol generating material transfer component.

Moreover, this may allow the article to be at least partly disassembled and reassembled without permanent damage thereto (e.g. by a suitable technician).

The article 100, including any features thereof, may be as defined elsewhere herein. For example, the aerosol generating component 130 may be substantially planar. The aerosol generating component 130 may be curved. The aerosol generating component 130 may be curved around an axis of the aerosol generating component 130. The aerosol generating material transfer component 150 may be curved around the axis of the aerosol generating component 130. The axis of the aerosol generating component 130 may correspond to the longitudinal axis of the aerosol generating component 130. The axis of the aerosol generating component 130 may correspond to the lateral (or transverse) axis of the aerosol generating component 130. The axis of the aerosol generating component 130 may correspond to the axis extending between electrical connectors 130C of the aerosol generating component.

The article 100 may comprise an aerosol forming chamber 130. The aerosol generating component may be at least partly located in the aerosol forming chamber 190.

In some examples, the aerosol generating component 130 may comprise one or more elongate apertures 130B (e.g. as depicted in FIG. 3). The aerosol generating component 130 may comprise a plurality of elongate heating portions. The plurality of elongate heating portions may be arranged side-by-side. An elongate apertures 130B may be provided between adjacent elongate heating portions. The aerosol generating component 130 may comprise one or more electrical connectors 130C. The elongate heating portions may be provided between the electrical connectors 130C. In some examples, the aerosol generating component 130 is formed of an electrically conductive material. In some examples, the aerosol generating material 130 is formed of a porous material. In some examples, the aerosol generating component 130 is formed of a single layer.

The article 100 may comprise any other features as defined herein.

There is also disclosed a non-combustible aerosol provision system 10 comprising: an article 100 as defined herein; and a device 20 comprising one or more of a power source and a controller.

The system 10 may comprise any other features as defined herein.

According to one aspect, there is disclosed an aerosol generating component comprising: at least two substantially planar portions, wherein at least two of the substantially planar portions lie in a different plane from each other.

By virtue of this arrangement, the substantially planar portions lying in a different plane can help to guide airflow within an article including the aerosol generating component in an optimised manner. For example, the different planes of the portions can guide airflow within the article in respective directions. Accordingly, by virtue of this arrangement, the aerosol generating component can be tailored to a particular design configuration of the article, so as to more effectively direct airflow and/or reduce or limit turbulence in the airflow.

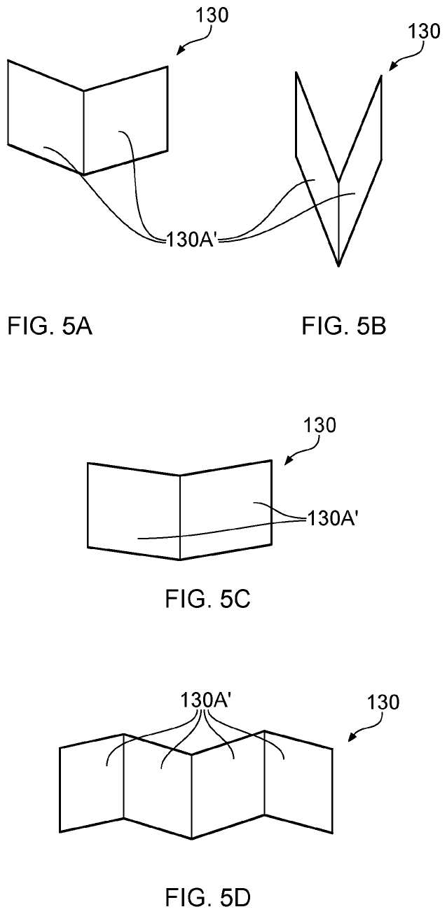

Features of this aspect are schematically illustrated in FIGS. 5A-D. As illustrated, the aerosol generating component 130 comprises at least two substantially planar portions 130A′. At least two of the substantially planar portions 130A′ lie in a different plane from each other.

In the examples of FIGS. 5A-C, the aerosol generating component 130 comprises two substantially planar portions 130A′. In the example of FIG. 5D, the aerosol generating component 130 comprises four substantially planar portions 130A′. It will be appreciated that other numbers of heating portions 130A′ may be used.

In some examples, at least two of the substantially planar portions 130A lying in a different plane define an oblique internal angle α. The internal angle may be between about 10° and about 80°, or between about 20° and about 70°, or between about 30° and about 60°, or between about 35° and about 55°, or between about 40° and about 50°, or about 45°.

In some examples, an end of at least two of the substantially planar portions 130A′ lying in a different plane are connected to each other end-to-end. This arrangement is illustrated in each of FIGS. 5A-C. In some examples, the aerosol generating component 130 is configured such that airflow travels perpendicular to a boundary between the at least two substantially planar portions 130A′ lying in a different plane. As shown in the FIGS., the boundary corresponds to the straight line connecting the portions 130A′.

In some examples, each of the at least two substantially planar portions 130A′ lying in a different plane defines a first direction, the respective first directions being parallel to each other, wherein the first directions are the only parallel directions defined by the planar heating portions 130A′. For example, referring to FIGS. 5A-C, each of the two substantially planar portions 130A′ lying in a different plane defines a first direction (along the width of the portion 130A′), and these first directions are parallel to each other. No other directions along the respective portions 130A′ are parallel to each other. It will be appreciated that various configurations are possible.

In some examples, the aerosol generating component 130 (e.g. one or each of the at least two substantially planar portions 130A′) may comprise one or more elongate apertures. For example, the aerosol generating component 130 (e.g. one or each of the at least two substantially planar portions 130A′) may comprise multiple elongate heating portions. These may be arranged side-by-side. An elongate aperture may be provided between adjacent elongate heating portions.

In some examples, the aerosol generating component 130 is formed of an electrically conductive material. In some examples, the aerosol generating component 130 is formed of a porous material. In some examples, the aerosol generating component 130 is formed of a single layer.

The aerosol generating component 130 may comprise one or more electrical connectors 130C. The elongate heating portions may be provided between the electrical connectors 130C.

There is also disclosed an article for use as part of a non-combustible aerosol provision system, the article comprising: the aerosol generating component 130 as defined herein; and one or more of a reservoir 121 for aerosolizable material, and an aerosol forming chamber 190.

The aerosol generating component 130 may be provided at least partly within the aerosol forming chamber 190. The article 100, e.g. the housing 110, 120, may comprise at least one air inlet 117 to the aerosol forming chamber 190.

The aerosol generating component 130 may be arranged to channel air entering the article 100 via the at least one air inlet 117 onto at least two of the substantially planar portions 130A′ lying in a different plane.

At least two of the substantially planar portions 130A′ lying in a different plane may be arranged to direct air entering the article 100 via the at least one air inlet 117 in different directions.

In examples where at least two of the substantially planar portions 130A′ lying in a different plane define an oblique internal angle, the oblique internal angle may be on the side of the aerosol generating component 130 distal from the at least one air inlet 117. Such an arrangement may help to direct airflow in intended different directions whilst reducing or limiting turbulence.

In some examples, the article 100 is configured such that airflow travels perpendicular to a boundary between the at least two substantially planar portions 130A′ lying in a different plane. As shown in the FIGS., the boundary corresponds to the straight line connecting the portions 130A′.

The article 100 may comprise any other features as defined herein.

There is also disclosed a non-combustible aerosol provision system 10 comprising: an article 100 as defined herein; and a device 20 comprising one or more of a power source and a controller.

The system 10 may comprise any other features as defined herein.

According to one aspect, there is disclosed an article for use as part of a non-combustible aerosol provision system, the article comprising: an aerosol generating component; and an aerosol generating material transfer component, the aerosol generating material component and the aerosol generating material transfer component being housed within the housing, wherein the aerosol generating component is urged against the aerosol generating material transfer component.

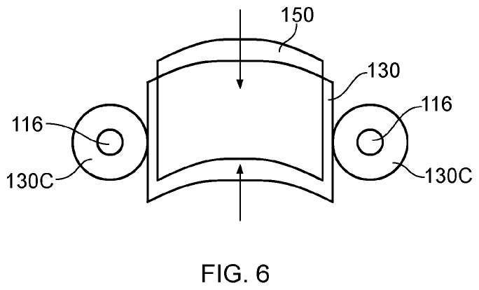

Features of this aspect are schematically represented in FIG. 6. The aerosol generating component 130 and the aerosol generating material transfer component 150 are housed within the housing 110, 120 (not shown in FIG. 6). The aerosol generating component 130 is urged against the aerosol generating material transfer component 150. In this configuration, the contact between the aerosol generating component 130 and the aerosol generating material transfer component is improved. For example, this configuration may facilitate improved delivery of aerosolizable material from the aerosol generating material transfer component to the aerosol generating component, and thus lead to improved aerosolization.

The urging of the aerosol generating component 130 against the aerosol generating material transfer component 150 may be achieved in various ways. For example, the aerosol generating component 130 may be securely attached to the housing 110, 120 or a component therein (e.g. electrical contacts 116). For example, the aerosol generating material transfer component 150 may be spatially constrained by the housing 110, 120 or a component therein (e.g. the flow regulator 140). The housing and/or a component or components therein may urge against each of the aerosol generating component 130 and the aerosol generating material transfer component 150. This may compress together the aerosol generating component 130 and the aerosol generating material transfer component 150.

For example, in one example, the aerosol generating component 130 is securely attached to electrical contacts 116, which retains the aerosol generating component 130 in position within the housing 110, 120; and the aerosol generating material transfer component 150 is spatially constrained by the flow regulator 140. Moreover, the housing 100 and the respective components therein are dimensioned so that once the article 100 is assembled, the aerosol generating component 130 urges against the aerosol generating material transfer component 150, e.g. so as to compress these components 130, 150 together.

With reference to FIG. 6, the facing arrows in FIG. 6 indicate the compressive forces exerted on the aerosol generating component 130 and the aerosol generating material transfer component 150 (the other features of the article 100 are not shown for clarity). In some embodiments, the aerosol generating component is pre-biased into a particular orientation. Such pre-biasing can allow for the aerosol generating component to maintain a particular degree of contact with the aerosol generating material. In particular, if the aerosol generating component is displaced from its pre-biased state when in contact with the aerosol generating material transfer component, it will attempt to move back to its pre-biased state and thus contact with the aerosol generating material transfer component can be enhanced. In some examples, the aerosol generating component 130 is substantially planar. In some examples, the aerosol generating component 130 is curved. In some examples, the aerosol generating component 130 is curved around an axis of the aerosol generating component 130. In some examples, the aerosol generating material transfer component 150 is curved around an axis of the aerosol generating component 130. The axis of the aerosol generating component 130 may correspond to an axis between electrical connectors 130C of the aerosol generating component 130. The axis of the aerosol generating component 130 may correspond to the longitudinal axis, or transverse (or lateral) axis, of the aerosol generating component 130.

In some examples, the housing 110, 120 may comprise an aerosol forming chamber 190. The aerosol generating component 130 may be at least partly located within the aerosol forming chamber 190.

In some examples, the aerosol generating component 130 may comprise one or more elongate apertures 130B (e.g. as depicted in FIG. 3). The aerosol generating component 130 may comprise a plurality of elongate heating portions. The plurality of elongate heating portions may be arranged side-by-side. An elongate aperture may be provided between adjacent elongate heating portions. The aerosol generating component 130 may comprise one or more electrical connectors 130C. The elongate heating portions may be provided between the electrical connectors 130C. In some examples, the aerosol generating component 130 is formed of an electrically conductive material. In some examples, the aerosol generating material 130 is formed of a porous material. In some examples, the aerosol generating component 130 is formed of a single layer.

The article 100 may comprise at least one airflow channel 180.

The article 100 may comprise any other features as defined herein.

There is also disclosed a non-combustible aerosol provision system 10 comprising: an article 100 as defined herein; and a device 20 comprising one or more of a power source and a controller.

The system 10 may comprise any other features as defined herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An article for use as part of a non-combustible aerosol provision system, the article comprising:
a housing having at least one air inlet; and
a substantially planar aerosol generating component, the substantially planar aerosol generating component being housed within the housing,
wherein the at least one air inlet is configured to channel air towards the aerosol generating component in an inlet airflow direction, wherein the plane of the substantially planar aerosol generating component is obliquely angled with respect to the inlet airflow direction.

2. An article as claimed in claim 1, wherein the plane of the substantially planar aerosol generating component is angled by about 140° to about 160° with respect to the inlet airflow direction.

3. An article as claimed in claim 2, wherein the plane of the substantially planar aerosol generating component is angled by about 130° to about 150° with respect to the inlet airflow direction.

4. An article as claimed in claim 1, wherein the plane of the aerosol generating component is obliquely angled with respect to the inlet airflow direction in one or two dimensions of the aerosol generating component.

5. An article as claimed in claim 1, wherein the aerosol generating component is obliquely angled with respect to the inlet airflow direction in only one dimension of the aerosol generating component.

6. An article as claimed in claim 1, wherein the housing comprises an aerosol forming chamber.

7. An article as claimed in claim 4, wherein the aerosol generating component is at least partly located within the aerosol-forming chamber.

8. An article as claimed in claim 1, wherein the housing defines a single air flow channel.

9. An article as claimed in claim 6, wherein the single airflow channel extends between the at least one air inlet and at least one air outlet.

10. An article as claimed in claim 1, wherein the aerosol generating component comprises one or more elongate apertures.

11. An article as claimed in claim 1, wherein the aerosol generating component is formed of an electrically conductive material.

12. An article as claimed in claim 1, wherein the aerosol generating component is formed of a porous material.

13. An article as claimed in claim 1, wherein the aerosol generating component is formed of a single layer.

14. An article as claimed in claim 1, wherein the aerosol generating component comprises one or more electrical connectors.

15. An article as claimed in claim 1, comprising a reservoir for aerosolizable material.

16. An article as claimed in claim 15, comprising an aerosol generating material transfer component configured to transfer aerosolizable material from the reservoir to the aerosol generating component.

17. A non-combustible aerosol provision system comprising:
an article as claimed in claim 1; and
a device comprising one or more of a power source and a controller.
